(19) United States
(12) Patent Application Publication
(10) Pub. No.: US 2007/0286098 A1
(43) Pub. Date: Dec. 13, 2007

(54) Computerized telephony accessibility provider (CTAP) for provisioning a talking telephone device

(76) Inventors: Fredrick D. Combs, Lafayette, LA (US); Brent L. O'Pry, Harahan, LA (US); Dustin R. Armstrong, Carencro, LA (US)

Correspondence Address: RAYMOND G. AREAUX, 1100 POYDRAS STREET, SUITE 2700, NEW ORLEANS, LA, 70163, US

(21) Appl. No.: 11/451,131

(22) Filed: Jun. 12, 2006

(51) Int. Cl. H04L 12/16

(52) U.S. Cl. 370/259

(57) ABSTRACT

A computerized telephony accessibility provider (CTAP) for provisioning a talking telephone device coupled to a personal computer, laptop, mobile telephone, or other computing device. The CTAP functions to audiblize the results of the operation of a telephone feature, navigation and interaction with a telephone device and featured incoming telephony signals (Caller ID and Message Waiting) from an external telephony source. The CTAP function in combination with a telephone device or as a standalone VoIP telephone device.

### BACKGROUND OF THE INVENTION

1. Field of the Invention

The present invention relates to telephone devices and more particularly to a computerized telephony accessibility provider (CTAP) for provisioning a talking telephone device.

2. General Background

There are numerous telephone devices including hardwired, software-based and wireless telephones. Telephone devices are provided with a plurality of functions or feature sets to be carried out by a set of keys or keyboard strokes. However, each telephone device can have a different set of telephone features and a different set of keys or key stroke combinations to activate any one feature.

Even for telephone devices of the same type, such as a softphone, different manufactures can have a different set of telephone features and different keys to activate a feature. For example, a user's work softphone may differ from the softphone at their home. Since the user may use the office softphone more often, the user can become more acquainted with the office softphone. Thus, when the user is at home, the user may struggle with the features of the home-based softphone.

The softphone and mobile phones provide little standardization in keystrokes to activate telephone features or the actual features available. Using a telephone becomes even more complicated when the user is vision impaired or physically handicapped.

Currently, unless a telephone user speaks multiple languages, they are limited to talking and communicating with only those who speak the same language. Although, the Voice over Internet Protocol (VoIP) allows users to call anywhere on earth wired for the Internet at little or no extra cost, the full potential of VoIP communications cannot be realized if the user is still limited to communications in their language.

In view of the above, there is a continuing need for a talking telephone device that is suitable for use by vision-impaired users and/or others with physical challenges.

In view of the above, there is a continuing need for a talking telephone device that is suitable for use by any user seeking to enhance and improve accessibility to the features of their telephone.

There is a need for a computerized telephony accessibility provider (CTAP) that accesses a softphone module, mobile phone module or other telephone device to audibly announce the result of activated telephone features and telephone status thereby provisioning a talking telephone device.

A further need is to provide a computerized telephony accessibility provider (CTAP) that is voice responsive to a set of voice commands.

A still further need is to provide a computerized telephony accessibility provider (CTAP) that universally standardizes keyboard keys to selectively activate telephone features of a softphone or hardwired telephone coupled to a personal computer, laptop or other computing device.

A still further need is to provide a computerized telephony accessibility provider (CTAP) that is adapted to function as a talking VoIP telephone device and does not require an additional telephone device.

As will be seen more fully below, the present invention is substantially different in structure, methodology and approach from that of other telephone devices.

### SUMMARY OF THE PRESENT INVENTION

An object of the present invention is to provide a wired or wireless talking telephone device that is also suitable for use by vision-impaired users and/or others with physical challenges.

An object of the present invention is to provide a wired or wireless talking telephone device that is also suitable for use by any user seeking to enhance and improve accessibility to the features of their telephone.

An object of the present invention is to provide a VoIP talking telephone device that is also suitable for use by vision-impaired users and/or others with physical challenges.

An object of the present invention is to provide a VoIP talking telephone device that is also suitable for use by any user seeking to enhance and improve accessibility to the features of their telephone

An object of the present invention is to provide a computerized telephony accessibility provider (CTAP) that audibly announces the result of a currently activated telephone feature, navigation and interaction response and/or telephone status for provisioning a talking telephone device.

An object of the present invention is to provide a computerized telephony accessibility provider (CTAP) that is voice responsive to a set of voice commands.

An object of the present invention is to provide a computerized telephony accessibility provider (CTAP) that universally standardizes keyboard keys to selectively activate telephone features of a softphone or hardwired telephone coupled to a personal computer, laptop or other computing device.

A further object of the present invention is to provide a computerized telephony accessibility provider (CTAP) that audibly announces featured (caller ID and/or message waiting indicator) incoming signals from the external telephone system, IP/PBX, network, wireless communication network or other external telephony source.

A still further object is to provide a computerized telephony accessibility provider (CTAP) that allows for automatic language translation and/or disability adaptations based on the sending and receiving parties language and/or disabilities.

In view of the above objects, the present invention contemplates a computerized telephony accessibility provider (CTAP) for use with a telephone device comprising: means for interfacing with an operating system; means for detecting actuation of a respective one telephone feature of a plurality of telephone features; and, means for performing the respective one telephone feature and announcing operation of the respective one telephone feature.

The present invention further contemplates program code executable by a processor comprising program instructions which upon execution are operable to interface with an operating system; detect actuation of a respective one telephone feature of a plurality of telephone features; perform the respective one telephone feature; and, audibly announce operation of the respective one telephone feature.

The present invention further contemplates a method for provisioning a talking telephone device comprising the steps of:
interfacing with an operating system;
detecting actuation of a respective one telephone feature of a plurality of telephone features;
performing the respective one telephone feature; and,
audibly announcing operation of the respective one telephone feature.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates a talking telephone device in accordance with the present invention;

FIG. 2 illustrates a general block diagram of a computerized telephony accessibility provider in accordance with the present invention;

FIG. 3A illustrates a general flow diagram of communication exchange signals for provisioning the talking telephone device;

FIG. 3B illustrates a general flow diagram of the communication exchange signals using a telephone application programming interface (TAPI) and TAPI-service provider (TSP) combination;

FIG. 3C illustrates a general flow diagram of the communication exchange signals using Java TAPI (JTAPI);

FIG. 3D illustrates a general flow diagram of the communication exchange signals using a session initiation protocol (SIP);

FIG. 4A illustrates a flow diagram of operational features provisioning a talking telephone device using the computerized telephony accessibility provider;

FIG. 4B illustrates a flow diagram of operation features provisioning a talking mobile telephone device using the computerized telephony accessibility provider;

FIG. 5A illustrates a flow diagram for handling incoming or outgoing calls by the talking telephone device via a IP/PBX using TAPI and TSP combination;

FIG. 5B illustrates a flow diagram for handling incoming or outgoing calls by the talking telephone device via using a modem or analog device drivers;

FIG. 5C illustrates a flow diagram for handling incoming or outgoing VoIP calls by the talking telephone device using a session initiation protocol;

FIG. 6A illustrates a flow diagram of the operations of the audible calls-on-hold notification sub-module;

FIG. 6B illustrates a calls on hold graphical user interface (GUI);

FIG. 7 illustrates a flow diagram of the operations of the audible system status notification sub-module;

FIG. 8 illustrates a flow diagram of the operations of the audible message waiting indicator (AMWI) sub-module;

FIG. 9A illustrates a block diagram of the talking telephone device coupled to a IP/PBX with voice mail;

FIG. 9B illustrates a block diagram of the talking telephone device coupled to a Telephone system 100′ with voice mail wherein the telephone device is a hardwired telephone device;

FIG. 9C illustrates a block diagram of the VoIP talking telephone device coupled to a network or proxy;

FIG. 10 illustrates a message disable graphical user interface (GUI);

FIG. 11A illustrates a last spoken message repository graphical user interface (GUI);

FIG. 11B illustrates a general block flow diagram for announcing a selected stored spoken message;

FIG. 12A illustrates the accessibility communication engine (ACE) sub-module in accordance with the present invention;

FIG. 12B illustrates a communication exchange diagram between two talking telephone devices coupled to the World-Wide-Web;

FIG. 13 illustrates a talking mobile telephone device in accordance with the present invention communicating with a wireless communication system; and,

FIG. 14 illustrates the talking mobile telephone device with a phonebook to announce a caller's name.

### DETAILED DESCRIPTION OF THE EXEMPLARY EMBODIMENT

### Definitions

TAPI: Telephony Application Programming Interface. TAPI enables Windows applications to share telephony devices with each other and provides a common means of handling different media (voice, data, fax, video, etc.) on a wide range of hardware platforms.
SIP: Session Initiation Protocol. A signaling protocol for Internet conferencing, telephone, presence, events notification and instant messaging.
TSP: TAPI service provider (TSP). TSP is a driver that allows TAPI applications to communicate with different types of TAPI hardware. Windows 95 and NT come with a built-in TSP called Unimodem. Unimodem is a “universal” modem service provider that supports a wide range of commonly used modems. When using telephony hardware other than modems, such as PBX's, voice processing cards, etc. typically a TSP is provided by the hardware vendor.

### JTAPI: Java TAPI.

SMTP: Simple Mail Transfer Protocol. SMTP is the de facto standard for email transmission across the Internet. SMTP is a relatively simple, text-based protocol, where one or more recipients of a message are specified (and in most cases verified to exist) and then the message text is transferred.
MAPI: Messaging Application Programming Interface. MAPI allows client programs to become (electronic mail) messaging-enabled, -aware, or -based by calling MAPI subsystem routines that interface with certain messaging systems and message stores (MAPI has its own temporary store in the MAPI spooler).
Softphone: a software that simulates a real phone and runs on a general purpose computer, rather than a dedicated device. It is usually used with a headset connected to a sound card of the personal computer or universal serial bus (USB) phone.

### VoIP: Voice over Internet Protocol (VoIP).

WCN: Wireless communication network (WCN). Includes cellular telephone networks, short or long range wireless communication networks, an radio frequency (RF) communication networks, satellite communication networks, personal communications services (PCS) communication networks.
Mobile telephone device: includes a wireless telephone, a cellular telephone, a personal communications services (PCS) device, personal digital assistant (PDA) device, a laptop computer, a notebook computer or a palm or hand-held computer.

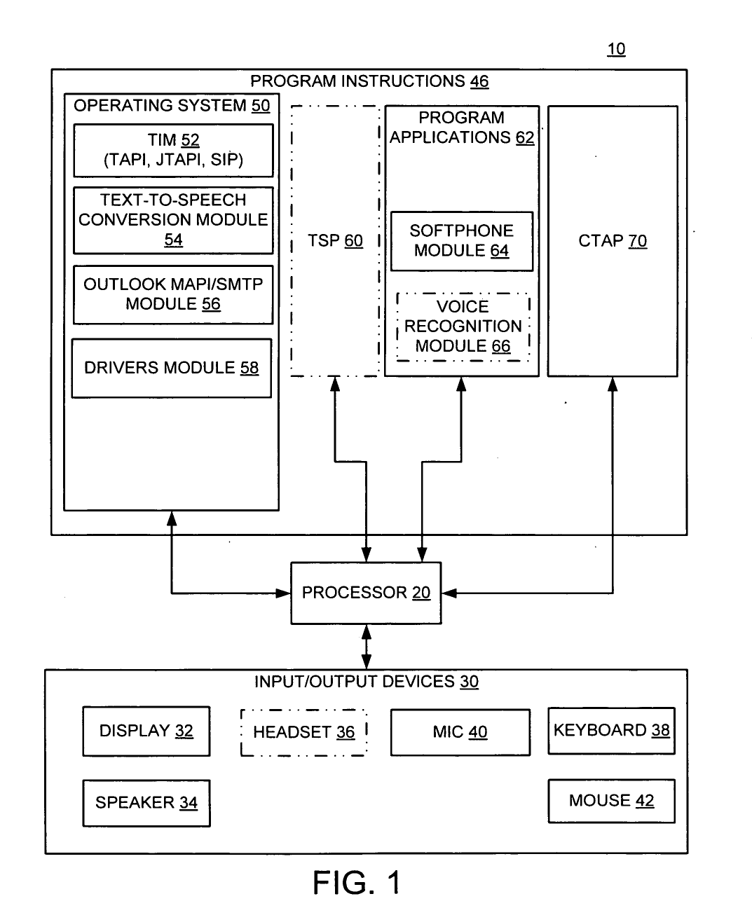

The exemplary embodiment of FIG. 1 is directed to a telephone device implemented using a personal computer (PC), laptop or other computing device, hereinafter referred to as a talking telephone device. However, this invention is susceptible of embodiments in many different forms. This specification and the accompanying drawings disclose only some forms as examples of the use of the invention. This invention is adapted for use in other devices wired or wireless that function to provide two-way voice communications over wired or wireless telephone systems.

The talking telephone device is also suitable for use by vision-impaired users and/or others with physical challenges.

Referring now to the drawings and in particular, FIG. 1, the talking telephone device is designated by the reference numeral 10. The talking telephone device 10 includes in general a processor 20 and a plurality of input/output devices 30 to allow the user to interact with the talking telephone device 10. The talking telephone device 10 further includes program instructions 46 stored in a computer readable medium, which upon execution carries out the telephony functions described herein. The program instruction include in general an operating system (OS) 50, an optional TAPI-service provider (TSP) 60, program applications 62 and a computerized telephony accessibility provider (CTAP) 70.

Typically, a personal computer (PC) includes numerous program applications 62 for carrying out various computing functions such as, without limitation, word-processing, accounting, and photographic processing. However, for the purposes of the present invention, the description herein is limited to program applications which provide telephone functions hereinafter referred to as a softphone module 64. An optional voice recognition module 66 is also included in the program applications 62 to allow voice commands to be entered, as will be described in more detail later. Examples of a voice recognition module 66 include, without limitation, Dragon Naturally Speaking® x and IBM's ViaVoice.

The computerized telephony accessibility provider (CTAP) 70 supports multiple operating system (OS) platforms. For example, the operating system (OS) 50 comprises one of Windows 9x, 2000, ME, XP or NT 4.x, Mac OS x, or the like. Furthermore, the OS 50 includes a telephony interface module (TIM) 52 comprising one of TAPI 52A, JTAPI 52B, SIP 52C or the like. The OS 50 further includes a text-to-speech (TTS) conversion module 54, an outlook MAPI/SMTP module 56 and drivers module 58 to support various hardware and software applications including various input/output devices 30, modems, etc.

The input/output devices 30 include a display 32, speaker 34, optional headset 36, keyboard 38, microphone 40, and mouse 42. As previously, described, the voice recognition module 66 can be used by the user to enter voice commands through the microphone 40 for navigation and control of at least the CTAP 70. Some users 5 may wish to use a headset 36 in lieu of the speaker 34 and microphone 40. Furthermore, a mouse 42 can be used to activate, initiate and navigate through the program instructions 46 of the talking telephone device 10 in a conventional manner.

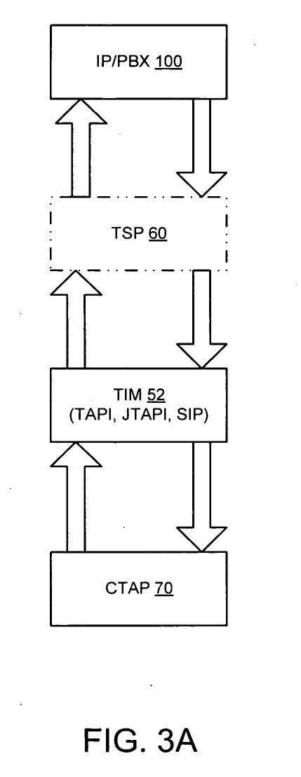

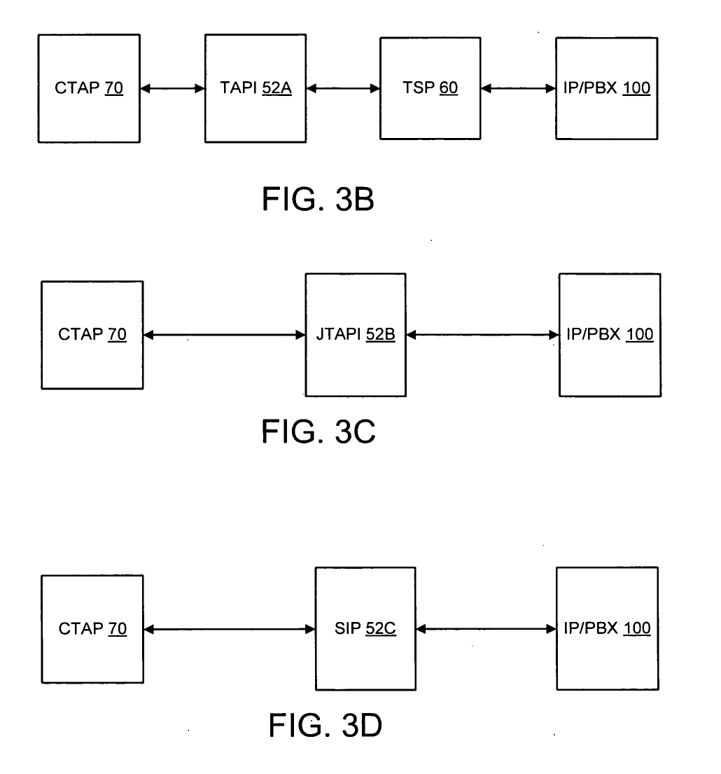

Referring now to FIGS. 3A-3D, the communications exchange between the CTAP 70 and the TIM 52 of the OS 50 will now be described. As best seen FIG. 3A, in general, the CTAP 70 interfaces and communicates with the TIM 52 of the OS 50. The TIM 52 interfaces and communicates with the TSP 60. Thereafter, the TSP 60 communicates with the IP/PBX 100. The communication exchange flows in the opposite direction from the IP/PBX 100 to the TSP 60 which in turn communicates with the TIM 52 of the OS 50. Thereafter, the TIM 52 communicates with the CTAP 70.

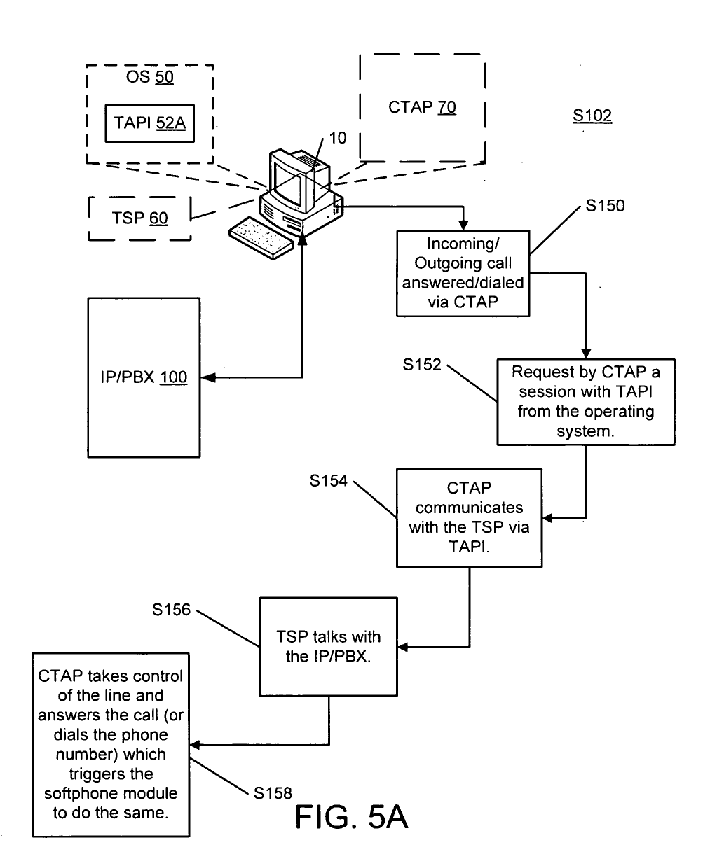

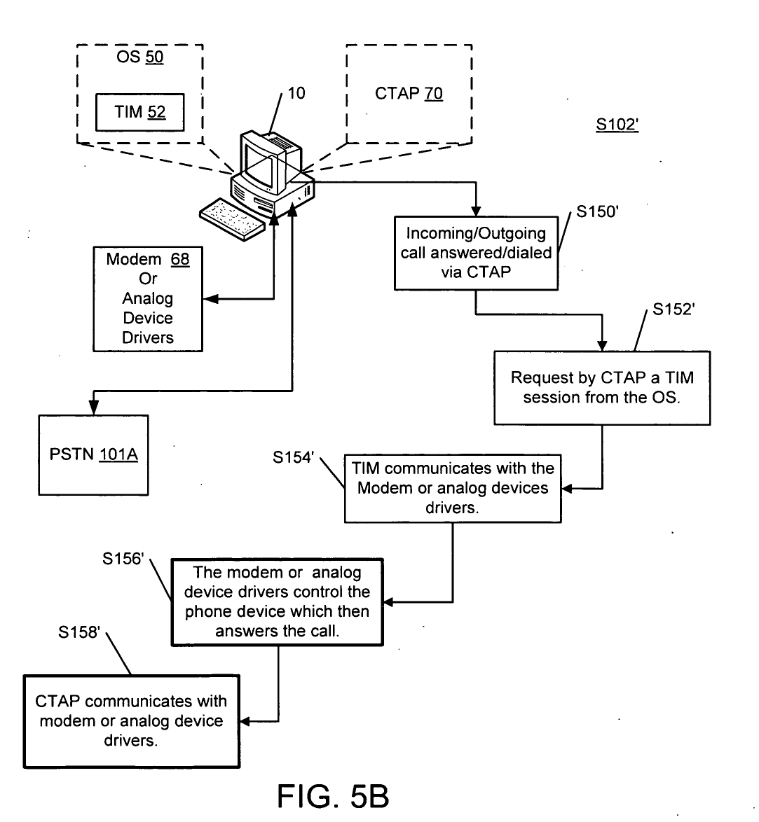

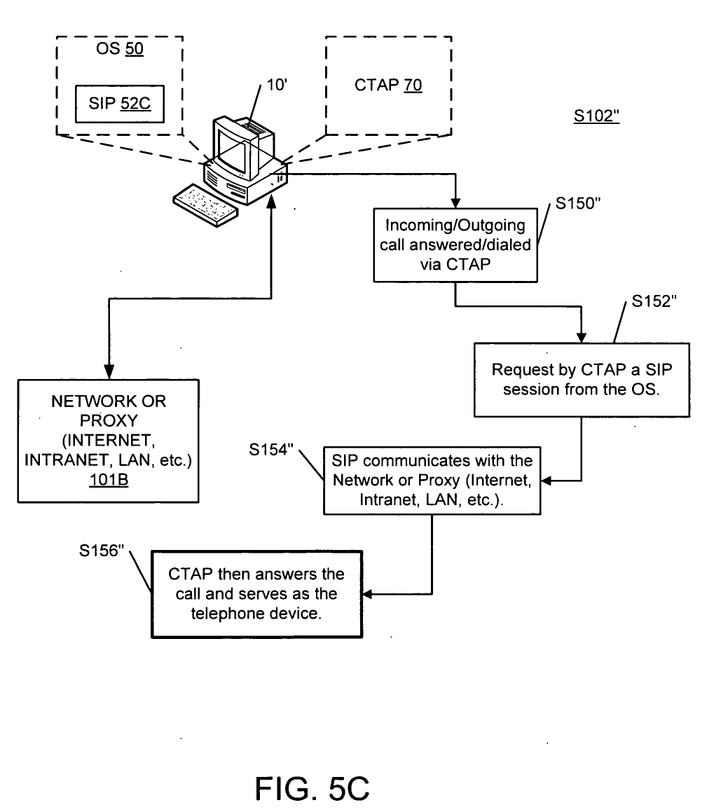

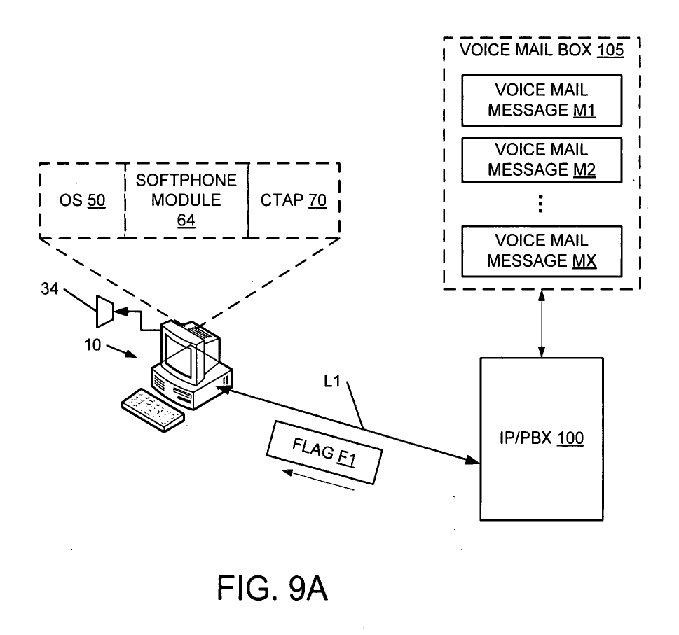

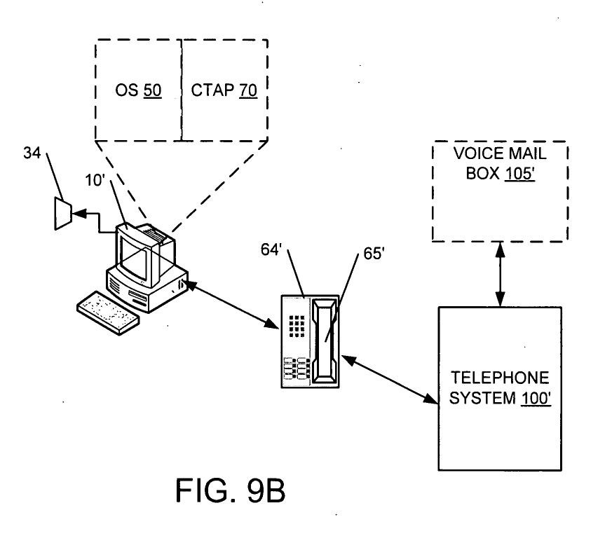

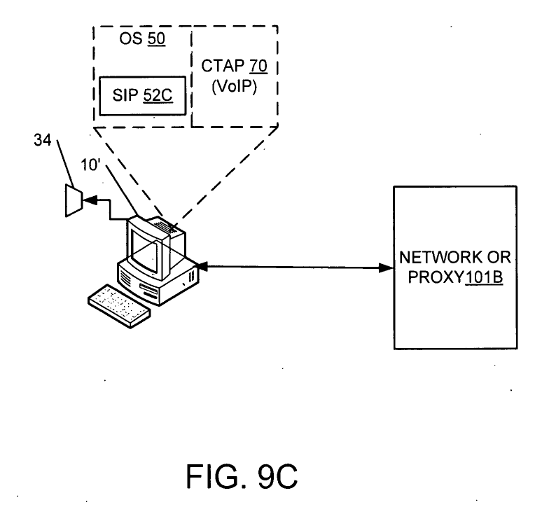

In FIG. 3B, the TIM 52 is a TAPI 52B. The exchange includes a TSP 60. In FIG. 3C, the TIM 52 includes a JTAPI 52B and the TSP 60 is not needed in the communications exchange. In FIG. 3D, the TIM 52 is a SIP 52C and the TSP 60 is not needed in the communications exchange. The communication exchange shown in FIG. 3D is suitable for VoIP telephone calls. Furthermore, the softphone module 64 can be eliminated from the talking telephone device. Hence, the talking telephone device without a softphone module 64 is designated as 10′ in FIG. 5C and FIGS. 9B and 9C.

In the exemplary embodiment, the CTAP 70 audibly announces through the speaker 34 or headset 36 the result of a currently activated telephone feature for provisioning a talking telephone device. Furthermore, the CTAP 70 audibly announces navigation and interaction responsive to the user's navigation and interaction response input via any of the input modes (voice recognition, mouse, keyboard, etc.) previously described. The CTAP 70 is also adapted to audible announce the telephone and call status.

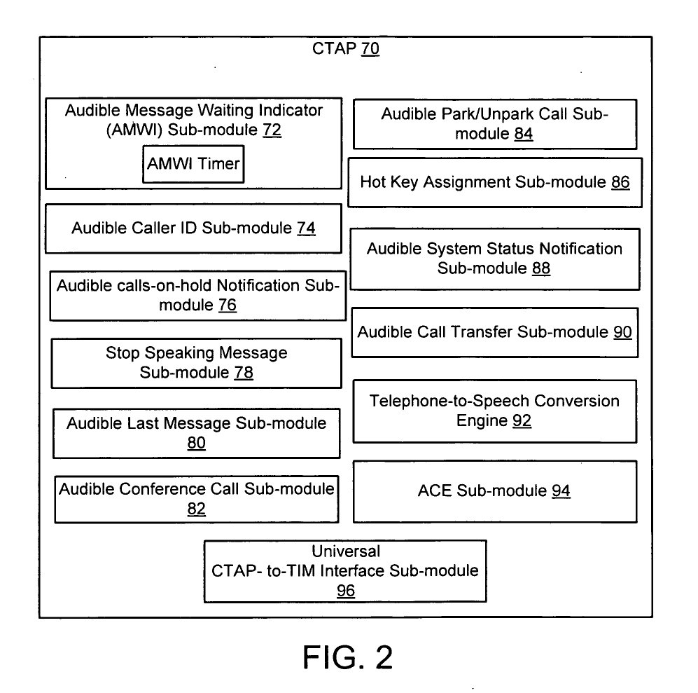

In operation, the softphone module 64 when installed provides the telephone functions when executed by processor 20. However, the CTAP 70 shown in FIG. 2 is operable upon execution by processor 20 to overlay audible messages providing audible announcements of each telephone feature supported by the softphone module 64. The CTAP 70 does not impose the CTAP 70 telephone features on the softphone module 64. Instead, the CTAP 70 universally adapts to the telephone feature set of the specific telephone device whether a softphone module 64, hardwired telephone device 64′ or standard mobile telephone device.

Referring now to FIG. 2, the CTAP 70 includes an audible message waiting indicator (AMWI) sub-module 72, an audible call ID sub-module 74, audible calls-on hold notification sub-module 76, stop speaking message sub-module 78, last message spoken sub-module 80, audible conference call sub-module 82, audible park/unpark call sub-module 84, hot key assignment sub-module 86, audible system status notification sub-module 88, and audible call transfer sub-module 90. The CTAP 70 further includes a telephone-to-speech conversion engine 92, accessibility communication engine sub-module 94 and a CTAP-to-TIM interface sub-module 96.

CTAP-to-TIM interface sub-module 96 allows the CTAP 70 to communicate with the TIM 52. The telephone-to-speech conversion engine 92 automatically translates the navigation and interaction inputs from the user into a signal suitable for text-to-speech conversion by the TTS conversion module 54, as will be described in more detail later. More specifically, the telephone-to-speech conversion engine 92 automatically translates all signals representative of an audibly announced message into a signal suitable for text-to-speech conversion by the TTS conversion module 54 of the OS 50. The CTAP 70 employs the TTS conversion module 54 of the OS 50 for provisioning the talking telephone device 10.

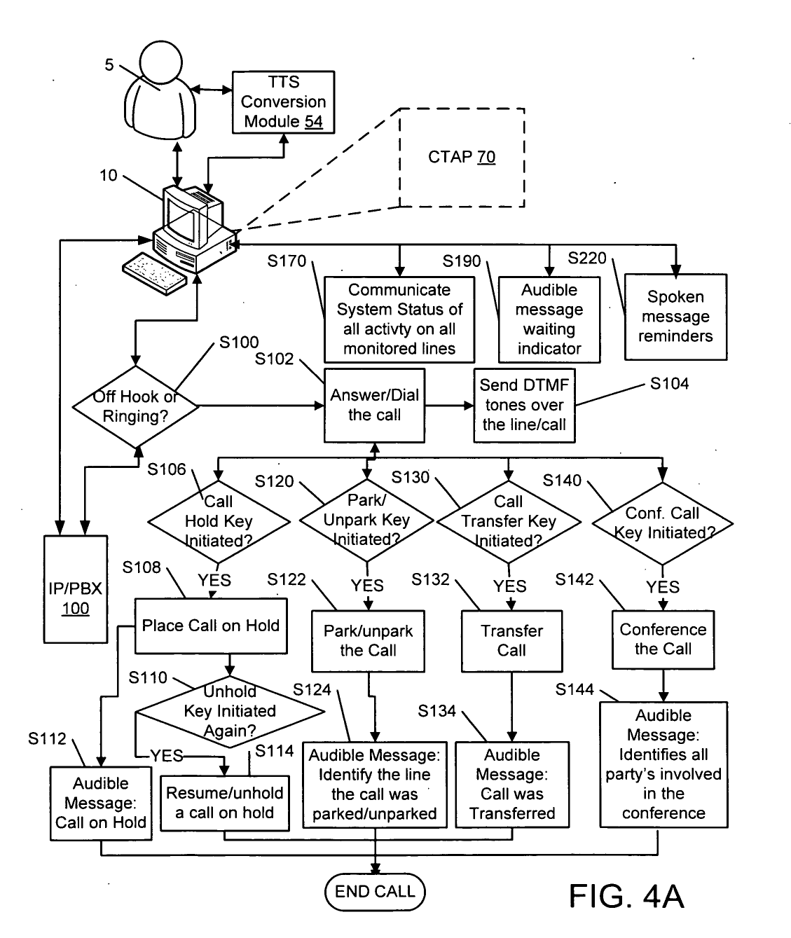

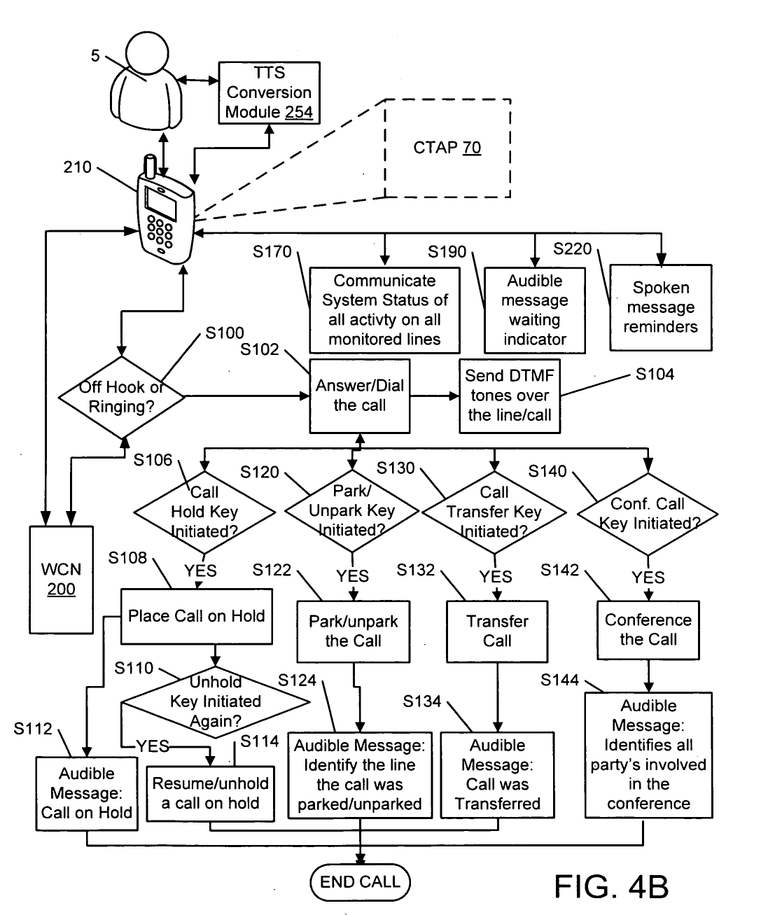

Referring now to FIG. 4A, the talking telephone device 10 is activated such as when there is a ringing tone on the line from the IP/PBX 100 or the user 5 initiates the dialing of a phone number. Hence, the process begins at step S100 when an off hook or ringing tone is detected at step S100. Step S100 is followed by step S102 where the call is either answered or dialed. If the user 5 dials a telephone number via the keyboard 38 or mouse 42, the DTMF tones are sent over the line at step S104. As a further alternative, the user 4 could employ the voice recognition module 66 to speak universally assigned voice commands to place the call and/or dial a phone number. Hereinafter, any reference to a user's input or activation of a key, encompasses all modes of input by the user.

Referring now to FIG. 5A, the process of step S102 is shown. The description provided at step S102 assumes the operating system 50 includes a TAPI 52A and a TSP 60. Step S102 begins with step S150 where the incoming or outgoing call is answered or dialed via the CTAP 70. Step S150 is followed by step S152 where the CTAP 70 requests a session with the TAPI 52A of the OS 50 via the CTAP-to-TIM interface sub-module 98. Step S152 is followed by step S154 where the CTAP communicates with the TSP 60 via the TAPI 52A. Step S154 is followed by step S156 where the TSP 60 talks to the IP/PBX 100. Step S156 is followed by step S158 where the CTAP 70 takes control of the line and answers the call (or dials the phone number) which triggers the softphone module 64 to do the same.

Referring now to FIG. 5B, an alternate process of step S102′ is shown. The process S102′ identifies the steps when the talking telephone device 10 employs a modem 68 or analog device drivers and connects to the public switched telephone network 101 in lieu of IP/PBX 100. The description provided at step S102′ assumes the operating system 50 includes TIM 52 without the need for a separate TSP. Step S102′ begins with step S150′ where the incoming or outgoing call is answered or dialed via the CTAP 70. Step S150′ is followed by step S152′ where the CTAP 70 requests a session with the TIM 52 of the OS 50 via the CTAP-to-TIM interface sub-module 96. Step S152′ is followed by step S154′ where the CTAP 70 communicates with the TIM 52 which communicates with the modem 68 or analog devices drivers. Step S154′ is followed by step S156′ where the modem 68 or analog device drivers control the softphone 64 which then answers the call. Step S156′ is followed by step S158′ where the CTAP 70 communicates with the modem 68 or analog device drivers.

Referring now to FIG. 5B, an alternate process of step S102′ is shown. The process S102′ identifies the steps when the talking telephone device 10 employs a modem 68 or analog device drivers and connects to the public switched telephone network (PSTN) 101A in lieu of IP/PBX 100. The description provided at step S102′ assumes the operating system 50 includes TIM 52 without the need for a separate TSP. Step S102′ begins with step S150′ where the incoming or outgoing call is answered or dialed via the CTAP 70. Step S150′ is followed by step S152′ where the CTAP 70 requests a session with the TIM 52 of the OS 50 via the CTAP-to-TIM interface sub-module 96. Step S152′ is followed by step S154′ where the CTAP 70 communicates with the TIM 52 which communicates with the modem 68 or analog devices drivers. Step S154′ is followed by step S156′ where the modem 68 or analog device drivers control the softphone 64 which then answers the call. Step S156′ is followed by step S158′ where the CTAP 70 communicates with the modem 68 or analog device drivers.

Referring now to FIGS. 5C and 9C, another alternate process of step S102″ is shown such as for VoIP telephone communications via a network or proxy 101B such as without limitation a server for communicating over the Internet, Intranet, Local Area Network (LAN), etc. The process S102″ identifies the steps when the talking telephone device 10′ does not include a softphone module 64. The description provided at step S102″ assumes the operating system 50 includes SIP 52C without the need for a separate TSP. Step S102″ begins with step S150″ where the incoming or outgoing call is answered or dialed via the CTAP 70. Step S150″ is followed by step S152″ where the CTAP 70 requests a session with the SIP 52C of the OS 50 via the CTAP-to-TIM interface sub-module 96. Step S152″ is followed by step S154″ where the CTAP 70 communicates with the SIP 52C which communicates with the network or proxy 101B. Step S154″ is followed by step S156″ where the CTAP 70 functions as the telephone device and/or answers the call.

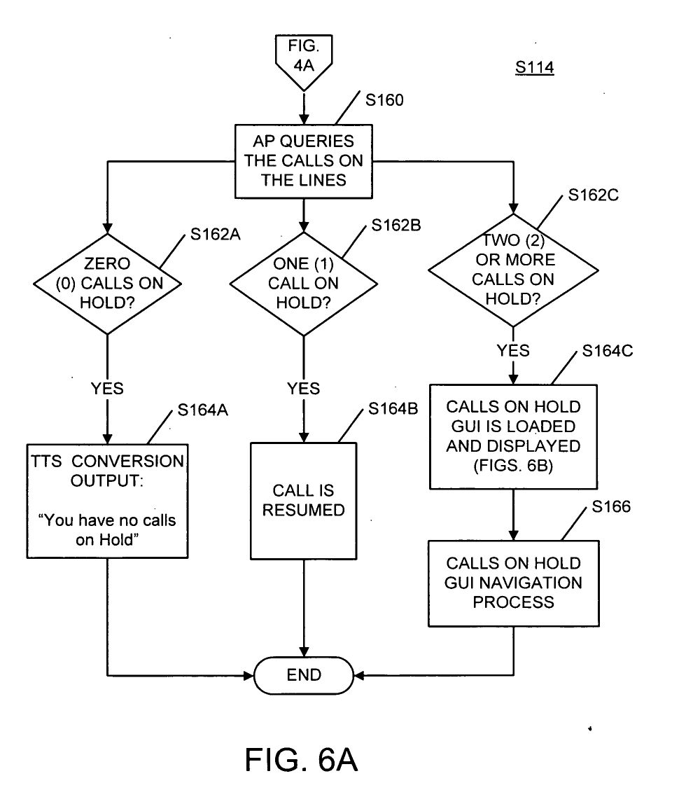

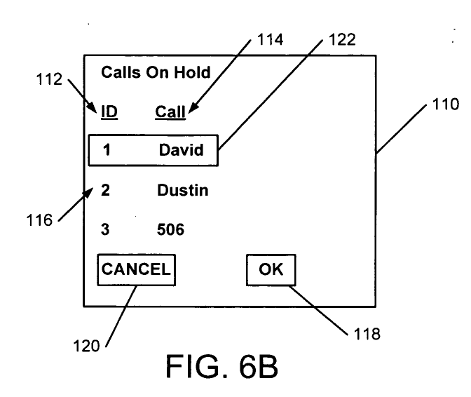

Returning again to step S102 of FIG. 4A, once the call is answered or dialed, the call can be placed on hold, parked, transferred, or a conference call established. The CTAP 70 waits for a hot key to be initiated via keyboard 38, input by mouse 42 or a voice command entered via the voice recognition module 66. At step S106, if the user 5 initiates the call hold function or key, then step S106 is followed by step S108 where the call is placed on hold via the audible calls-on-hold notification sub-module 76 and generates an audible message at step S112 via the TTS conversion module 54. An exemplary message may include “Call on Hold.” Step S108 is also followed by step S110 where the CTAP 70 waits for a call un-hold key to be initiated. If the call unhold key is initiated, then the call on hold is resumed at step S114 via a resume process described in relation to FIGS. 6A and 6B. As can be readily sent, the CTAP 70 generates a message that announces the result of the telephone feature operation selected.

Referring now to FIGS. 6A and 6B, when the call unhold key is initiated at step S110, the process of step S114 begins with step S160 where the CTAP 70 queries the calls on the lines (provided the device 10 supports multiple lines). Step S162 is followed by step S162A, S162B or S162C. At step S162A, the CTAP 70 determines that there are zero (0) calls on hold. Step S162A is followed by step S164A where the TTS conversion module 54 outputs the audible announcement that “You have no calls on hold.” Other similar messages conveying that there are no calls on hold can be utilized. On the other hand, if the CTAP 70 determines that there is one (1) call on hold, at step S162B, step S162B is followed by step S164B. At step S164B, the call is resumed. On the other hand if at step S162C the CTAP 70 determines that there are two or more calls on hold, step S162C is followed by step S164C where a calls on hold graphical user interface (GUI) 110 is loaded and displayed, as best seen in FIG. 6B. Step S164C is followed by step S166 where the calls on hold GUI navigation process ensues as will be described in relation to FIG. 6B. Steps S164A, S164B and S166 end the step S114.

The calls on hold GUI 110 includes a first column 112 which lists an identification (ID) number representative of the order of the calls on hold were received. The ID number “1” denotes the first caller to be placed on hold in the list shown. The calls on hold GUI 110 also includes a second column 114 which identifies the name of the caller associated with the identification number. The list 116 includes a name which can be captured from the caller identification stream. However, if the name is not provided in the caller identification stream, the CTAP 70 would query other sources of caller identification as will be described later in relation to the mobile telephone device 210. Other sources can include, without limitation, caller speed dial list or the stored phone book.

As the user 5 navigates through the call list 116 of all calls on hold, a highlight bar 122 highlights a single entry/line in the list 116. In the exemplary embodiment, the caller with ID “1” and name “David” is shown highlighted by highlight bar 122. As the user navigates using the calls on hold GUI 110, when the entry in list 116 is highlighted by the highlighted bar 122, the TTS conversion module 54 audibly announces the ID number and/or the caller's name associated with the ID number. Scrolling or moving the highlight bar 122 via the keyboard 38 would highlight a different entry line. In lieu of the caller's name, the caller's telephone number could be announced and/or displayed. In the exemplary embodiment, the number denoted as “506” represents the speed dial number. In view of the foregoing description, the CTAP 70 further audibly announces messages indicative of navigation and interaction responsive to the user's navigation and interaction input.

The calls on hold GUI 110 further includes an OK button 118 and a cancel button 120. If the OK button 118 is selected, the highlighted entry line in the list 116 is selected thereby resuming the call associated with the highlighted entry line and the display of the calls on hold GUI 110 is closed. Selecting the cancel button 120 closes the display of the calls on hold GUI 110.

On the other hand, if the user presses the “ENTER” key of the keyboard 38, the highlighted entry line in the list 116 is selected thereby resuming the call associated therewith and closes the calls on hold GUI 110. When the call is resumed, an audible message would announce the result of resuming the call.

Returning again to FIG. 4A, if the CTAP 70 detects at step S120 that the park/unpark key is initiated, then step S120 is followed by step S122 where the call is parked or unparked by the audible park/unpark call sub-module 84. Step S122 is followed by step S124 where an audible announcement is provided to identify the line on which the call was parked or unparked.

If the CTAP 70 detects at step S130 that the call transfer key is initiated. Step S130 is followed by step S132 where the call is transferred by the audible call transfer sub-module 92. Step S132 is followed by step S134 where the TTS conversion module 54 output an audible announcement that the “call has been transferred.”

If the CTAP 70 detects at step S140 that the conference call key is initiated. Step S140 is followed by step S142 where the conference call is established via the audible conference call sub-module 82. Step S142 is followed by step S144 where the TTS conversion module 54 outputs an audible announcement which identifies all parties involved in the conference call.

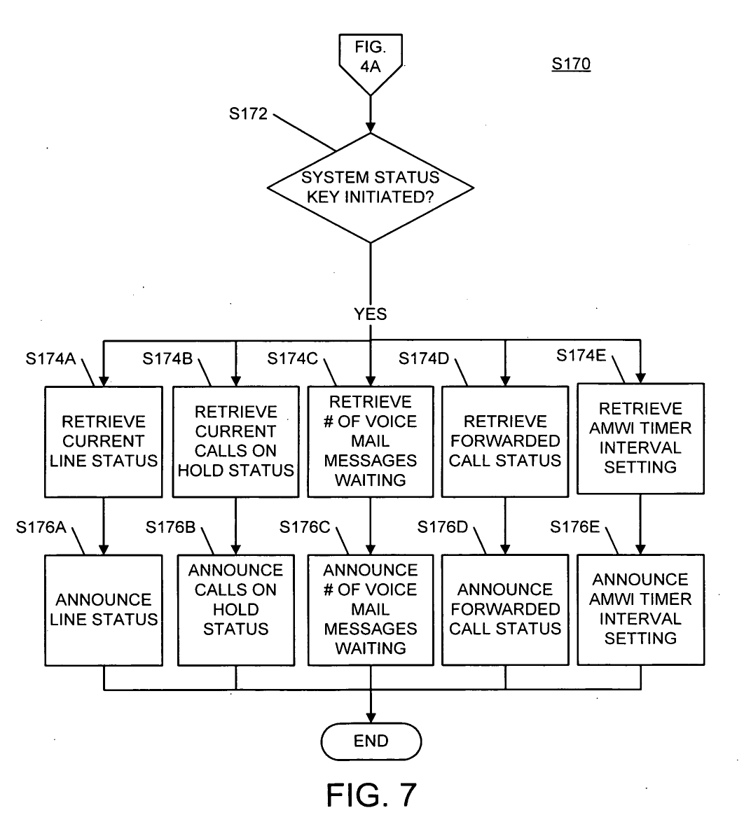

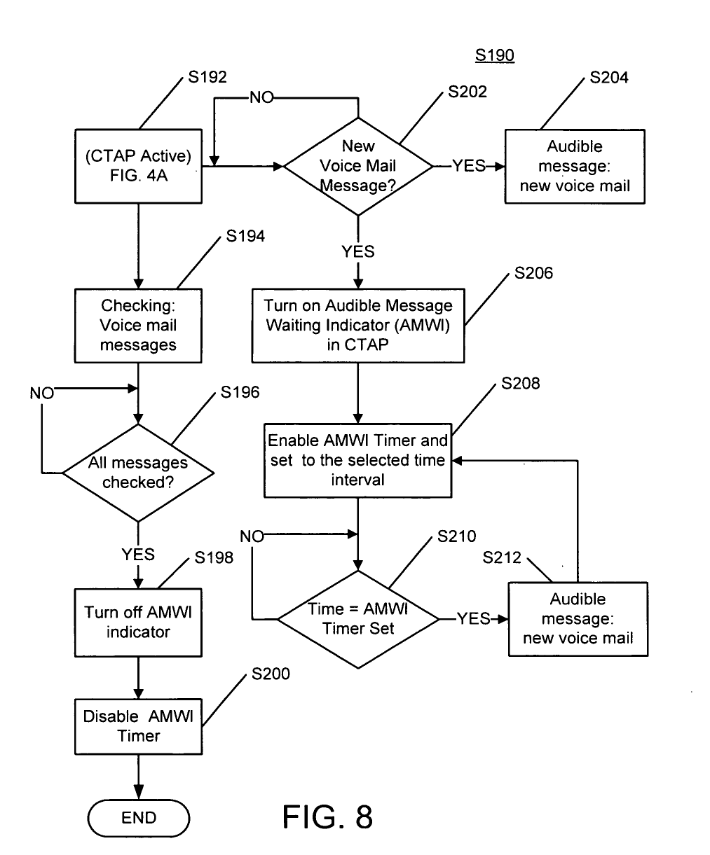

The monitoring and operation of the CTAP 70 also includes step S160 where the system status is determined by the audible system status notification sub-module 88 of the CTAP 70 if the system status key is initiated, as will be described in relation to FIG. 7. The CTAP 70 further includes step S190 where the CTAP 70 audibly announces whether a message is waiting in voice mail which will be described in relation to FIGS. 8 and 9. Moreover, the CTAP 70 is designed to audibly announce spoken message reminders at step S220.

The CTAP 70 functions to audibly announce when a new message is waiting (AMWI) only in those instances when the user has subscribed to such a service. For example, if a user's telephone service with a telephone system 100′ does not include voice mail feature, than the telephone system 100′ does not provide the flags for use by the CTAP 70 for that functionality. Likewise, if a user's telephone device does not have voice mail activated in the IP/PBX 100, then the AMWI announcement is not provided.

Referring now to FIG. 7, step S170 of FIG. 4A will now be described. If the CTAP 70 detects the activation of the system status key at step S172, the CTAP 70 retrieves the current line status at step S174A, the current calls on hold at step S174B, the number of voice mail messages at step S174C, the status of forwarded calls at step S174D and the audible message waiting indicator (AMWI) timer interval setting at step S174E. Step S174A is followed by step S176A where the CTAP 70 via the TTS conversion module 54 announces the line status such as idle or active. Step S174B is followed by step S176B where the CTAP 70 via the TTS conversion module 54 announces the calls on hold status. Step S174C is followed by step S176C where the number # of voice mail messages waiting is announced. Step S174D is followed by step S176D where the status of call forwarded is announced. Step S174E is followed by step S176E where the AMWI timer interval setting is announced. Steps S176A-176E end the process of step S170. The above description is illustrative of telephone status announcements when provisioning the talking telephone device 10.

Referring now to FIGS. 8 and 9A, the process of step S190 to provide audible message waiting indicator (AMWI) is shown and begins at step S192. At step S192 the CTAP 70 is active and monitors the phone line L1 from the IP/PBX 100 for a flag F1. The flag F1 is any signal provided by the IP/PBX 100 that would indicate to the user 5 when at least one message M1, M2, . . . MX is stored in voice mail box 105 at the IP/PBX 100. The flag F1 may be in the form of a stuttering tone on the line when the telephone goes off-hook heard through the speaker 34. Some telephones turn on an LED automatically to notify to the user of stored voice mail messages.

Step S192 is followed by step S194 where the user can check their messages. The CTAP 70 determines whether all messages M1, M2, . . . MX are checked at step S196. If all messages M1, M2, . . . MX are checked, step S196 is followed by step S199 where the announcement of the AMWI is turned off. Step S198 is followed by step S200 where the AMWI timer is disabled.

Step S192 is also followed by step S202 where a determination is made where there is a new voice message in the voice mail box 105. If the determination is “YES,” step S202 is followed for step S204 where an audible announcement is generated indicating the user has a “new voice mail.” Additionally, if there is a new voice mail at step S202, step S202 is followed by step S206 where the audible message waiting indicator (AMWI) of the CTAP 70 is turned on or activated. Step S206 is followed by step S208 where the AMWI timer is enabled and the selected time interval is set. Step S208 is followed by step S210 where the CTAP 70 monitors the time to determine if the time since the last announcement is equal to the AMWI timer setting. If the determination is “YES,” step S210 is followed by step S212 where an audible announcement indicating the user has new voice mail is generated and set to the speaker 34. Step S212 returns to step S208 where the timer is reset. The loop defined by steps S208, S210 and S212 is repeated until the AMWI is turned off at step S198, turned off by the user or the talking telephone device 10 is turned off.

Referring also to the audible caller ID sub-module 74, the caller identification, whether telephone number, speed dial number, name and/or other caller identifier is audibly announced when received from an external telephony source (IP/PBX 100 and Telephone System 100′). Likewise, the AWMI sub-module 72 audibly announces a message indicative of a new call waiting at the external telephony source, responsive to a signal received from such external telephony source. In view of the foregoing description, the CTAP 70 audibly announces featured (caller ID and/or message waiting indicator) incoming signals from the external telephone system, IP/PBX, network, or external telephony source.

At step S220, the CTAP 70 monitors for an activation of a dedicated key or input for repeating or announcing the last message uttered by audible last message sub-module 80 of the CTAP 70. The CTAP 70 retrieves the last spoken message and repeats or announces the last spoken message through speaker 34. Furthermore, the CTAP 70 monitors for an activation of a dedicated key or input to stop the announcement of at least one message via the stop speaking message sub-module 78.

Referring now to FIG. 10, the audible last message sub-module 80 includes a message disable graphical user interface 150. The message disable GUI 150 allows the user to customize the audible message set by selectively deactivating one or more or all of the audible messages. In the exemplary embodiment, all audible messages provided by the CTAP 70 are activated and designated as default. Thereby, the message disable GUI 150 would allow any one or more or all of the audible messages to be disabled. For the purposes of illustration, a list 152 of messages of the message set that can be disabled is shown. Each message entry 156 in the list 152 is associated with a selector box 154 for disabling the announcement of one or more messages. The message disable GUI 150 includes a Cancel button 158 and an OK button 160. Selecting the OK button 160 disables any of the selected messages selected and closes the message disable GUI 150. Selecting the cancel button 158 also cancels the message disable GUI 150. Navigation and interaction with the message disable GUI 150 is also audiblized.

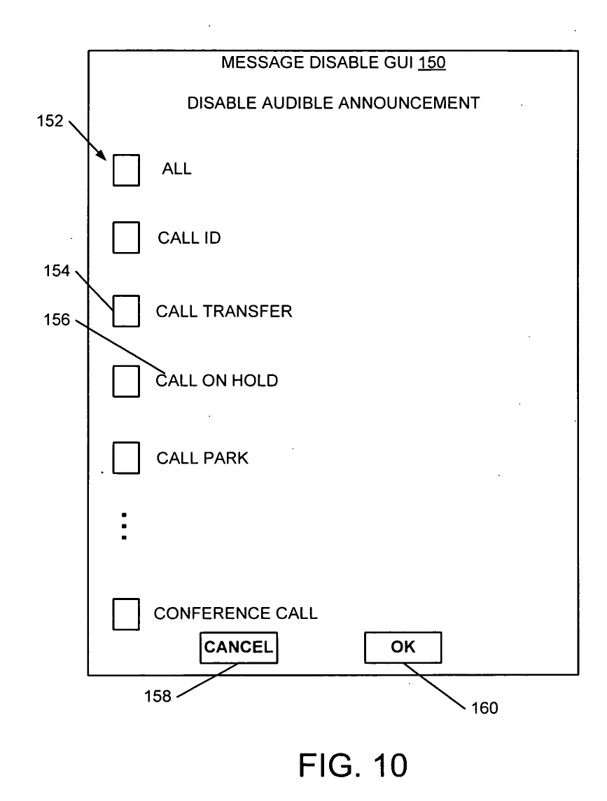

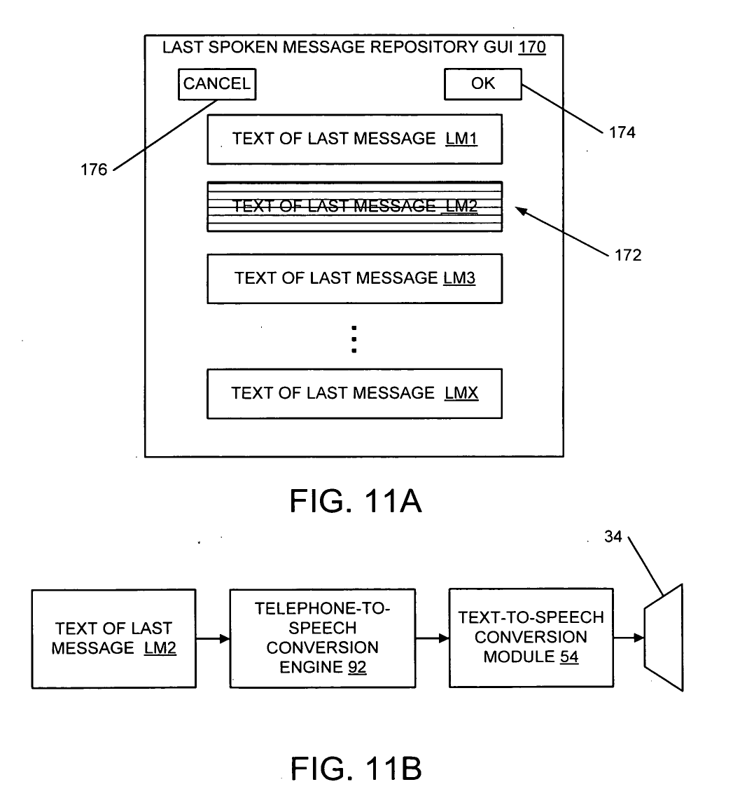

Referring now to FIGS. 11A-11B, the audible last message sub-module 80 stores all spoken announcements in sequential order in memory. The audible last message sub-module 80 also includes a last message repository GUI 170 which displays the list of audibly announced messages in the form of text. The number of stored messages varies on the size of the memory allocated to the message repository and the size of the announcement. In the exemplary embodiment, the last message repository GUI 170 displays the text of last message LM1, LM2, LM3, . . . , LMX in sequential order. The user is able to navigate and select any one of the stored text messages LM1, LM2, LM3, . . . , LMX where LM2 is shown highlighted. The last message repository GUI 170 includes a Cancel button 176 and an OK button 174. Selecting the OK button 174 sends the selected last message to the telephone-to-speech conversion engine 92 which sends the text message to the text-to-speech conversion module 54 and closes the last message repository GUI 170. Selecting the cancel button 176 also closes the last message repository GUI 170.

In general, all of the messages representative of the audible announcements are stored as text. The telephone-to-speech conversion engine 92 provides the necessary interface to communicate the text messages of the CTAP 70 so that the messages are audibly announced for provisioning the talking telephone device 10 by the TTS conversion module 54 of the OS 50.

Referring now to FIG. 9B, an alternate embodiment of the talking telephone device 10′ is shown. In this embodiment, in lieu of a softphone 64, the device 10′ includes a hardware telephone 64′ having a handset 65′ coupled to the personal computer, laptop or other computing device. In the embodiment of FIG. 1 or FIG. 9B, the telephone signals may be sent through a telephone system 100′ which may or may not include a public switched telephone network (PSTN) 101A. The telephone system 100′ includes voice mail box 105′ which may be provided by a IP/PBX 100 or the PSTN 101A. The operation to announce the AMWI message described in relation to FIG. 8 would still function the same.

The hardware telephone 64′ may be a stand telephone or a Voice over Internet Protocol (VoIP) telephone. Likewise, the softphone 64 may comprise a soft VoIP telephone.

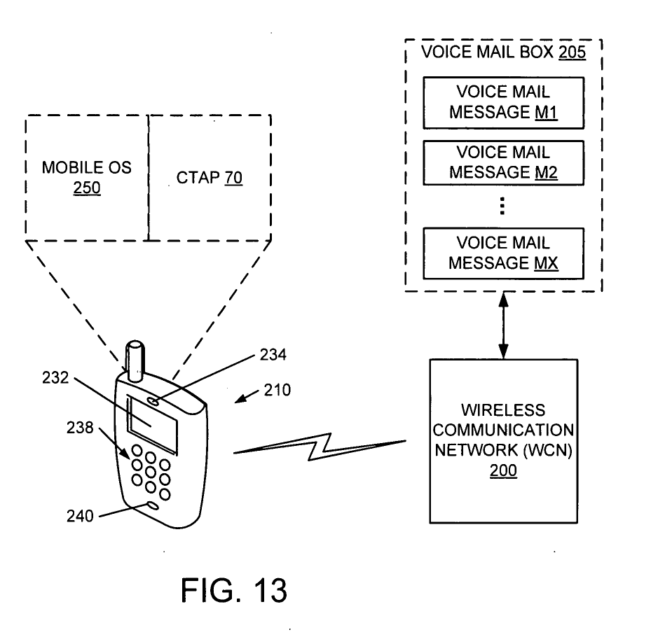

Referring now to FIG. 13, a still further alternate embodiment is shown. In the embodiment of FIG. 13, the talking telephone device 10 is replaced with a talking mobile telephone device 210 or talking mobile voice communication device. The talking mobile telephone device 210 has a mobile handset shape including a display 232, speaker 234, microphone 240 and keypad 238. The mobile telephone device 210 includes program instructions to carryout various functions well known in mobile telephony. The mobile telephone device 210 includes program instructions such as mobile OS 250. The mobile telephone device 210 further includes CTAP 70 for provisioning of the talking mobile telephone device 210.

In FIG. 13, the mobile telephone device 210 is shown communicating with a wireless communication network (WCN) 200 having a voice mail box 205. Conventionally, when the voice mail box has at least one message M1, M2, . . . MX, a flag is sent to the mobile telephone device 210 where a message is displayed on display 232 that the user has voice messages. The user can retrieve the voice mail messages M1, M2, . . . MX through the WCN 200. The CTAP 70 functions in a similar manner as shown in FIG. 8 to audibly announce through the speaker 234 that new voice mail messages are waiting.

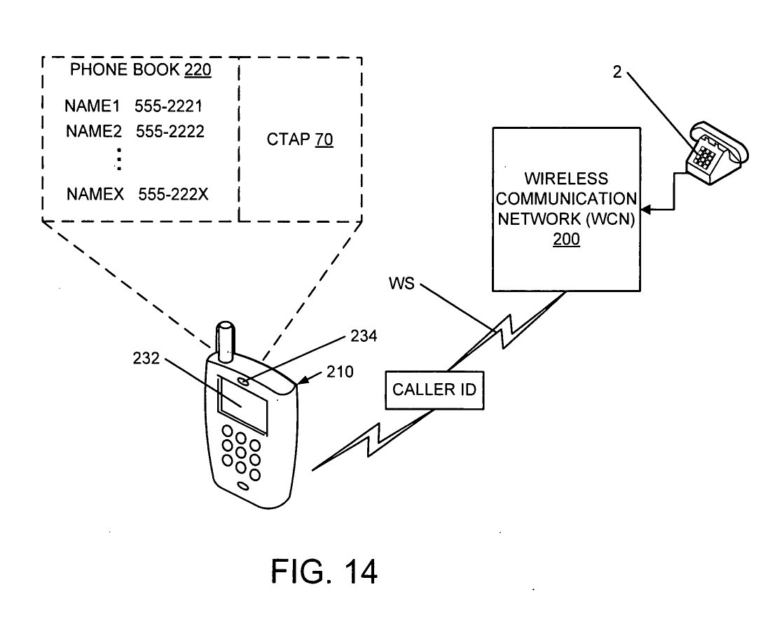

Furthermore, with specific reference to FIG. 14, the WCN may communicate the caller identification of calling party denoted as phone 2. The talking mobile telephone device 210 also includes a phone book 220 adapted to store names and associated telephone numbers frequently called by the user. The CTAP 70 announces the caller ID. The CTAP 70 uses the caller identification sent in the communication signal WS from the WCN 200 to look up the name in the phone book 220 or other source of names provided at the talking mobile telephone device 210.

The talking mobile telephone device 210 is a mobile telephone device having CTAP 70 stored therein wherein upon execution of its program instructions provides for the provisioning of a talking mobile telephone device.

Referring also to FIG. 4B, the CTAP 70 functions in the same manner as the CTAP 70 of FIG. 4A but supports mobile telephone operations. Recent developments in mobile telephone communications provides various features such as three-way calling or conference calling, multiple lines for placing calls on hold, etc. Therefore, the CTAP 70 of FIG. 4B is capable of providing the same audible announcements through the TTS conversion module 254 of the Mobile OS 250 for provisioning a talking mobile telephone device 210.

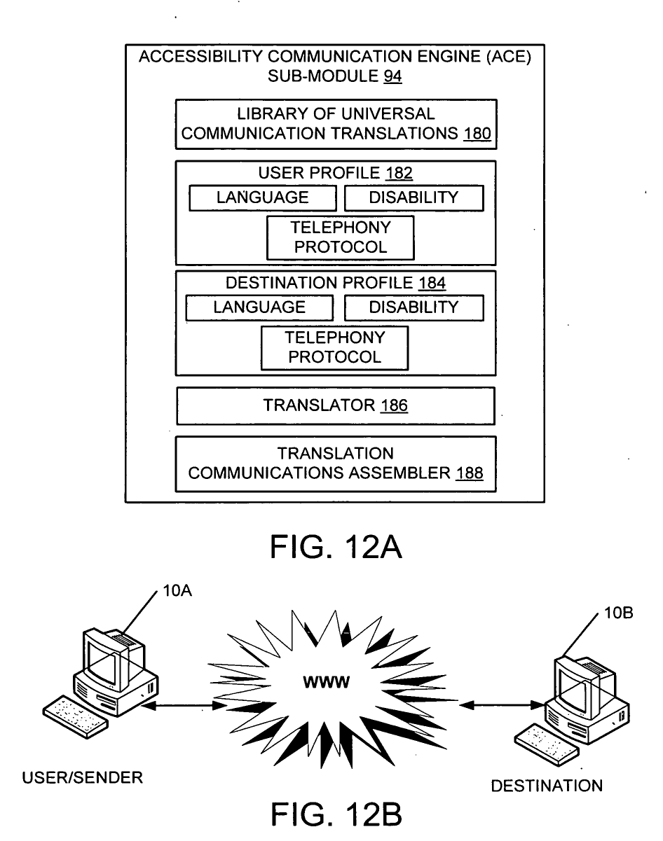

The ACE sub-module 94 is shown in FIG. 12A and includes a library of universal communication translations 180. No matter what method of communication between two parties such as user and destination, the communications can be converted and translated to fit the preferred method of the receiving party (destination), as best seen in FIG. 12B.

In general, if user/sender of talking telephone device 10A is a blind, Spanish speaking person and wants to communicate with a deaf, English reading person designated as destination using the talking telephone device 10B, then the ACE sub-module 94 will intervene between the two parties and handle the conversion of data so the individuals can effectively communicate as close to real-time as possible via the talking telephone devices 10A and 10B.

In the exemplary embodiment, the ACE sub-module 94 uses H.323 or SIP 52C. Furthermore, the ACE sub-module 94 of the user sends a request to the destination. A user's profile is sent to the destination. The user's profile is stored in the user profile 182 and may include information such as language and a disability. The destination accepts the request and sends a response back. With the response back, the user/sender receives the profile of the destination 184 which also may include a language, disability (if any) and telephony protocol. The communication method is determined between the two parties and a connection is established. The data is converted and standardized by the translator 186. The communication data (voice, video, or data) is then exchanged between the parties (10A and 10B) by a session via a translation communications assembler 188.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

1. An computerized telephony accessibility provider (CTAP) for use with a telephone device comprising:
means for interfacing with an operating system associated with the telephone device;
means for detecting actuation of a respective one telephone feature of a plurality of telephone features; and,
means for performing the respective one telephone feature and audibly announcing a result of performing the respective one telephone feature.

2. The CTAP of claim 1, wherein the respective one telephone feature includes call on hold.

3. The CTAP of claim 2, further comprising:
a calls on hold graphical user interface which displays a calls on hold list of a plurality of calls on hold;
means for highlighting an entry in the list; and
means for announcing a name and identification number of a call on hold corresponding to the entry being highlighted.

4. The CTAP of claim 1, further comprising:
means for monitoring for a new voice mail message; and,
means for audibly announcing a message indicative of the new voice mail message.

5. The CTAP of claim 4, further comprising:
a timer;
means for setting a timer interval to repeat the message indicative of said new voice mail message; and,
means for disabling the timer and the message when all voice mail messages are retrieved.

6. The CTAP of claim 5, wherein the plurality of telephone features includes calls on hold and call forward.

7. The CTAP of claim 6, further comprising:
means for retrieving and announcing a telephone device status.

8. The CTAP of claim 7, wherein the means for retrieving and announcing the telephone device status includes:
means for retrieving and announcing a telephone line status;
means for retrieving and announcing current calls on hold;
means for retrieving and announcing a number of voice mail messages waiting;
means for retrieving and announcing forwarded call status; and,
means for retrieving and announcing the timer interval.

9. The CTAP of claim 1, further comprising:
means for stopping audible announcement of the result.

10. The CTAP of claim 1, further comprising:
means for repeating a last audible announcement of the result.

11. The CTAP of claim 1, further comprising:
means for associating each respective telephone feature to at least one key of a keypad or keyboard of the telephone device to actuate said each respective telephone feature.

12. The CTAP of claim 1, further comprising:
means for audibly announcing a caller identification.

13. The CTAP of claim 1, wherein the plurality of telephone features includes calls on hold, call forward, call transfer, and call park/unpark and conference calling.

14. The CTAP of claim 1, wherein the actuation detecting means is voice responsive.

15. The CTAP of claim 1, wherein the operating system is for one of a personal computer and laptop.

16. The CTAP of claim 15, wherein the telephone device is a softphone module.

17. The CTAP of claim 16, wherein the softphone module supports a Voice over Internet Protocol (VoIP).

18. The CTAP of claim 1, wherein the telephone device is a mobile telephone device.

19. The CTAP of claim 1, wherein the operating system supports wireless communications.

20. Computer readable medium having program code executable by a processor, the program code comprising program instructions which upon execution are operable to
interface with an operating system associated with a telephone device;
detect actuation of a respective one telephone feature of a plurality of telephone features;
perform the respective one telephone feature; and,
audibly announce a result of the performance of the respective one telephone feature.

21. The computer readable medium of claim 20, wherein the respective one telephone feature includes call on hold.

22. The computer readable of claim 21, wherein the program instructions are further operable upon execution to
display a calls on hold graphical user interface which displays a calls on hold list of a plurality of calls on hold;
highlight an entry in the list; and
announce a name and identification number of a call on hold corresponding to the entry being highlighted.

23. The computer readable medium of claim 20, wherein the program instructions are further operable upon execution to
monitor for a new voice mail message; and
audibly announce a message indicative of the new voice mail message.

24. The computer readable medium of claim 23, wherein the program instructions are further operable to
provide a timer;
set a timer interval to repeat the message indicative of said new voice mail message; and,
disable the timer and the message when all voice mail messages are retrieved.

25. The computer readable medium of claim 24, wherein the plurality of telephone features includes calls on hold and call forward.

26. The computer readable medium of claim 25, wherein the program instructions are further operable to
retrieve and announce a status of a telephone device.

27. The computer readable medium of claim 26, wherein the program instructions operable to retrieve and announce the status include program instructions operable to retrieve and announce a telephone line status;
retrieve and announce current calls on hold;
retrieve and announce a number of voice mail messages waiting;
retrieve and announce forwarded call status; and,
retrieve and announce the timer interval.

28. The computer readable medium of claim 20, further comprising program instructions operable to
stop audible announcement of the result.

29. The computer readable medium of claim 20, further comprising program instructions operable to
repeat a last audible announcement of the operation of the respective one telephone feature.

30. The computer readable medium of claim 20, further comprising program instructions operable to
associate each respective telephone feature to at least one key of a keypad or keyboard of a telephone device to actuate said each respective telephone feature.

31. The computer readable medium of claim 20, further comprising program instructions operable to
audibly announce a caller identification.

32. The computer readable medium of claim 20, wherein the plurality of telephone features includes calls on hold, call forward, call transfer, call park/unpark and conference calling.

33. The computer readable medium of claim 20, wherein the operating system is for one of a personal computer and laptop.

34. The computer readable medium of claim 20, wherein the operating system supports mobile or Internet communications.

35. A method for provisioning a talking telephone device comprising the steps of:
interfacing with an operating system associated with a telephone device;
detecting actuation of a respective one telephone feature of a plurality of telephone features; for provisioning the talking telephone device
performing the respective one telephone feature; and,
audibly announcing a result of the performing of the respective one telephone feature for provisioning the talking telephone device.

36. The method of claim 35, wherein the respective one telephone feature includes call on hold.

37. The method of claim 36, further comprising the steps of:
displaying a calls on hold graphical user interface with a calls on hold list of a plurality of calls on hold;
highlighting an entry in the list; and
announcing a name and identification number of a call on hold corresponding to the entry being highlighted.

38. The method of claim 35, further comprising the steps of:
monitoring for a new voice mail message; and
audibly announcing a message indicative of the new voice mail message.

39. The method of claim 38, further comprising the steps of:
setting a timer interval of a timer to repeat the message indicative of said new voice mail message; and,
disabling the timer and the message when all voice mail messages are retrieved.

40. The method of claim 39, wherein the plurality of telephone features includes calls on hold and call forward.

41. The method of claim 40, further comprising the step of:
retrieving and announcing a status of the telephone device.

42. The method of claim 41, wherein the status retrieving and announcing step includes the steps of:
retrieving and announcing a telephone line status;
retrieving and announcing current calls on hold;
retrieving and announcing a number of voice mail messages waiting;
retrieving and announcing forwarded call status; and,
retrieving and announcing the timer interval.

43. The method of claim 35, further comprising the step of:
stopping audible announcement of the result.

44. The method of claim 35, further comprising the step of:
repeating a last audible announcement of the operation of the respective one telephone feature.

45. The method of claim 35, further comprising the step of:
associating each respective telephone feature to at least one key of a keypad or keyboard of the telephone device to actuate said each respective telephone feature.

46. The method of claim 35, further comprising the step of:
audibly announcing a caller identification of an incoming call.

47. The method of claim 35, wherein the plurality of telephone features includes calls on hold, call forward, call transfer, call park/unpark and conference calling.

48. The method of claim 35, wherein the detecting step is responsive to voice commands.

49. The method of claim 35, wherein the operating system is for one of a personal computer and laptop.

50. The method of claim 35, wherein the operating system supports wireless communications.

51. A computerized telephony accessibility provider (CTAP) for use with or without a telephone device interfaced with a processor comprising:
means for audibly announcing a result of a currently activated telephone feature,
means for audibly announcing navigation and interaction responsive to a user's navigation and interaction input for provisioning a talking telephone device.
